(19) United States
(12) Patent Application Publication
(10) Pub. No.: US 2015/0117021 A1
(43) Pub. Date: Apr. 30, 2015

(54) OMNIDIRECTIONAL LIGHT EMITTING DIODE LENS

(71) Applicant: GE Lighting Solutions, LLC, East Cleveland, OH (US)

(72) Inventors: Jeyachandrabose CHINNIAH, East Cleveland, OH (US); Thomas CLYNNE, East Cleveland, OH (US); Thomas Alexander KNAPP, East Cleveland, OH (US); Benjamin Lee YODER, East Cleveland, OH (US)

(21) Appl. No.: 14/453,857

(22) Filed: Aug. 7, 2014

Related U.S. Application Data
(60) Provisional application No. 61/896,193, filed on Oct. 28, 2013.

(51) Int. Cl. F21V 13/04; F21K 99/00; F21V 29/00; F21V 5/04; F21V 7/00

(52) U.S. Cl. CPC F21V 13/04; F21V 5/04; F21V 7/0091; F21V 29/22; F21K 9/58; F21Y 2101/02
USPC 362/294; 362/335; 362/327; 362/308

(57) ABSTRACT

Provided is an omnidirectional lens, having a housing having a closed end and an open end, a series of facets circumferentially arranged on the housing; and a series of concentric facets disposed on the closed end.

### I. FIELD OF THE INVENTION

The present invention relates generally to light emitting diode (LED) lamps. More particularly, the present invention relates to an omnidirectional LED lamp with thin Fresnel-like ring lens inside a diffuser.

### II. BACKGROUND OF THE INVENTION

Currently, LED lamps and light bulbs are replacing traditional incandescent lamps and other types of lamps. Traditional incandescent lamps (e.g., filament bulbs) produce an omnidirectional luminous intensity distribution. In contrast, LED sources produce a Lambertian distribution in which the light is emitted in one hemisphere and the luminous intensity decreases as a function of the cosine of the angle of the emitted light ray with respect to the axis normal to the emitting plane. Existing LED lamps use various shapes of optics to produce omnidirectional light. Those optics include diffusers, lenses, reflectors, and combinations thereof. Optical efficiency is an important design consideration for LED lamps, particularly for omnidirectional lamps attempting to achieve uniform light distribution. In general, more optical elements will increase losses and therefore decrease optical efficiency. Current solutions attempt to achieve omnidirectional light distribution by using thick lens internal reflectors, sideways positioning of LEDs, and thick total internal reflection (TIR) lenses and thin TIR disks, which can be bulky and costly.

### III. SUMMARY OF EMBODIMENTS OF THE INVENTION

Given the aforementioned deficiencies, a need exists for an optical system that combines a thin TIR ring lens, similar to a Fresnel lens, and a diffuser in an omnidirectional LED lamp meeting the Energy Star requirements established by the EPA. Specifically, the lamp should exhibit a uniform intensity distribution, within a 25% tolerance, over range from 0 to 135 degrees around the lamp. The omnidirectional lens and diffuser system should work well for A19, A21 or similar type of lamp configurations, such as but not limited to candelabra lamps. Finally, lens and diffuser system should have low optical losses with an optical efficiency above 85%.

Embodiments of the present invention include an omnidirectional lens, having a housing with a closed end and an open end, a series of facets circumferentially arranged on the housing; and a series of concentric facets disposed on the closed end.

In another illustrative embodiment, an omnidirectional lens is provided that includes a housing having a closed end and an open end, the housing having a refraction zone, a total internal reflection side zone and a total internal reflection top zone, and a light source disposed within the housing. The omnidirectional lens further includes a first series of facets circumferentially arranged on the housing, a second series of facets circumferentially arranged on the housing and a series of concentric facets disposed on the closed end.

In yet another embodiment, a lamp system, including a diffuser, an omnidirectional lens disposed within the diffuser, and a heat sink coupled to the diffuser is provided.

Specific implementations of some of the embodiments include an omnidirectional lens having a housing having a closed end and an open end, a first series of facets circumferentially arranged on the housing, a second series of facets circumferentially arranged on the housing and a series of concentric facets disposed on the closed end.

Further features and advantages of the invention, as well as the structure and operation of various embodiments of the invention, are described in detail below with reference made to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### IV. BRIEF DESCRIPTION OF THE DRAWINGS

The accompanying drawings, which are incorporated herein and form part of the specification, illustrate the present invention and, together with the description, further serve to explain the principles of the invention and to enable a person skilled in the relevant art(s) to make and use the invention.

FIG. 1 illustrates a side view of an exemplary omnidirectional lens.

FIG. 2 illustrates a cross sectional internal view of the exemplary omnidirectional lens of FIG. 1.

FIG. 3 illustrates a cutaway perspective bottom view of the omnidirectional lens of FIGS. 1-2.

FIG. 4 is a top view of the omnidirectional lens of FIGS. 1-3.

FIGS. 5 and 6 illustrate example ray trace diagrams.

FIG. 7 illustrates a side view of the omnidirectional lens 100 of FIGS. 1-4, showing lens details and angles.

FIG. 8 illustrates a close up detailed view of a first series of circumferentially arranged facets.

FIG. 9 illustrates an embodiment of a diffuser that can be implemented with the omnidirectional lens of FIGS. 1-4 in a lamp system.

FIG. 10 illustrates a table showing an exemplary normalized intensity distribution.

### V. DETAILED DESCRIPTION OF EMBODIMENTS OF THE INVENTION

While the present invention is described herein with illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

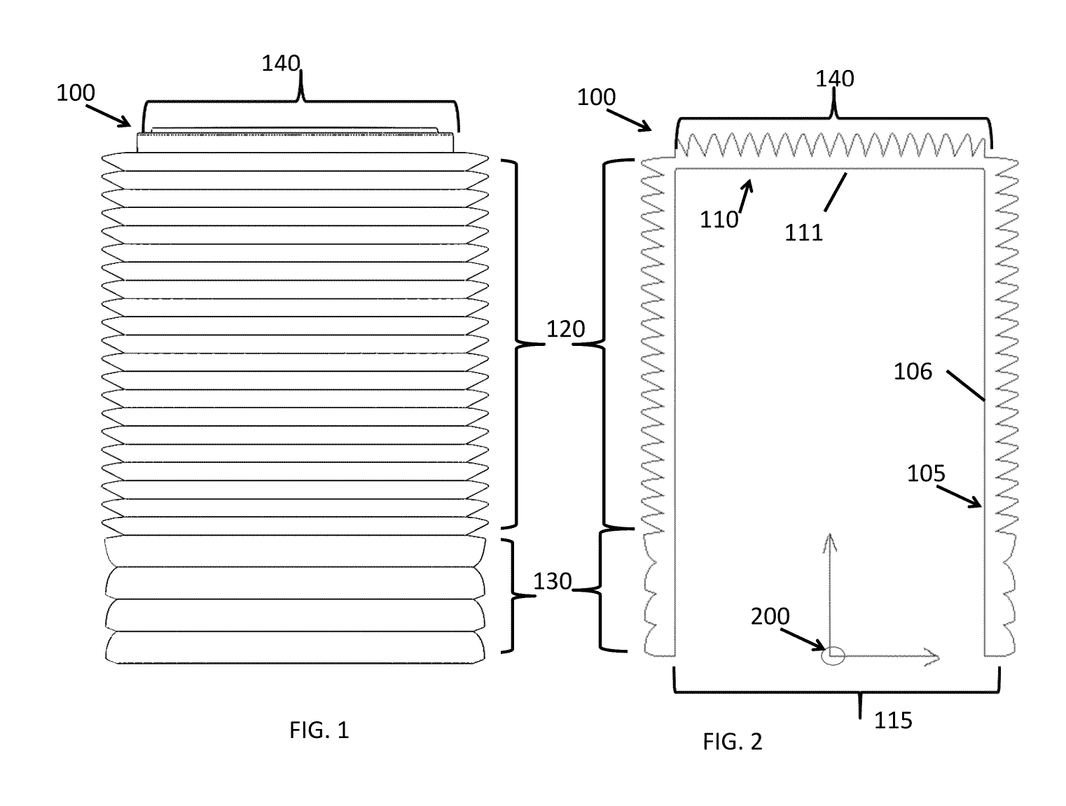

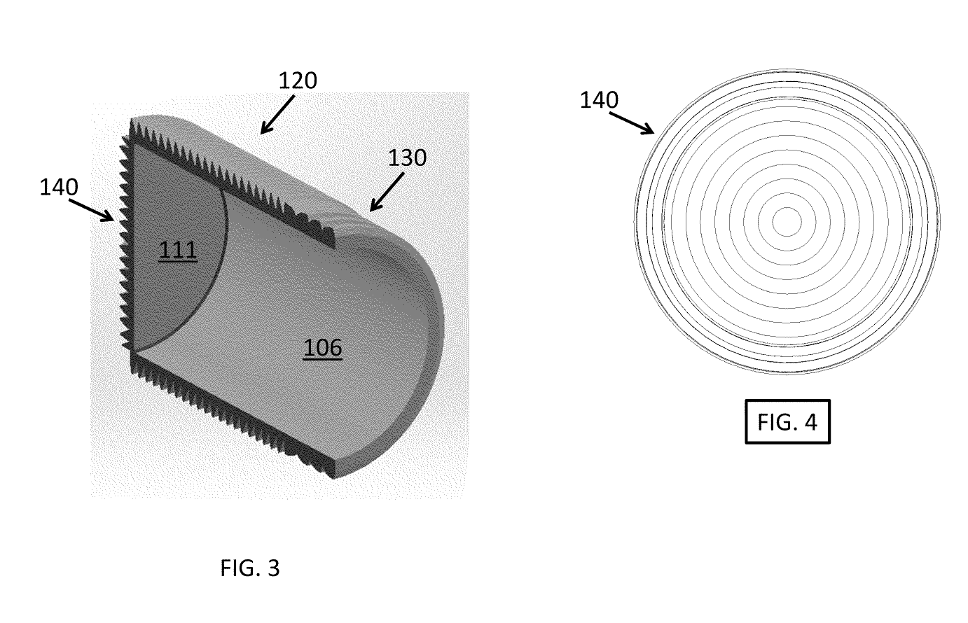

FIG. 1 illustrates a side view of an exemplary omnidirectional lens 100, FIG. 2 illustrates a cross sectional internal view of the exemplary omnidirectional lens 100 of FIG. 1, and FIG. 3 illustrates a cutaway perspective bottom view of the omnidirectional lens 100 of FIGS. 1-2. In one embodiment, the omnidirectional lens 100 includes a housing that is a cylinder having a side wall 105 with a smooth inner surface 106, a closed circular end 110 having a smooth inner surface 111 and an open end 115.

The omnidirectional lens 100 includes a thin Fresnel-like ring lens arrangement, which is illustrated in FIGS. 1 and 2 as a first series of circumferentially arranged facets 120 about the side wall 105. The omnidirectional lens 100 also includes a thin refractive ring lens arrangement, which is illustrated in FIGS. 1 and 2 as a second series of circumferentially arranged facets 130 about the side wall 105, adjacent the first series of the circumferentially arranged facets 120, and the open end 115. In one embodiment, the omnidirectional lens 100 further includes a series of concentrically arranged facets 140 arranged on the closed end 110. FIG. 4 illustrates a top view of the omnidirectional lens 100 of FIGS. 1-3, further illustrating the concentrically arranged facets 140.

It will be appreciated that although the embodiments described herein have been described with the omnidirectional lens 100 as a cylinder, the omnidirectional lens 100 can be cylindrical, spherical, conical or a combination of these shapes. The omnidirectional lens 100 can also have arbitrarily shaped curved geometry.

Referring again to FIG. 2, an idealized point light source 200 is shown for illustrative purposes. It will be appreciated that as described herein, the point light source refers to an idealized source used solely to simplify the behavior of the facets. In contrast, any non-idealized light source, such as a solid-state light source, does not exhibit this simple behavior. It will therefore be understood, that a facet designed to completely control the light from a point will allow some uncontrolled light to escape the facet when a real source is employed. This difference in behavior must to be taken into account during the design process in order to ensure that the desired intensity distribution is created when a real light source is employed. As used herein, the term “solid-state light source” (or SSL source) includes, but is not limited to, light-emitting diodes (LEDs), organic light-emitting diode (OLEDs), polymer light-emitting diodes (PLEDs), laser diodes, lasers, and the like.

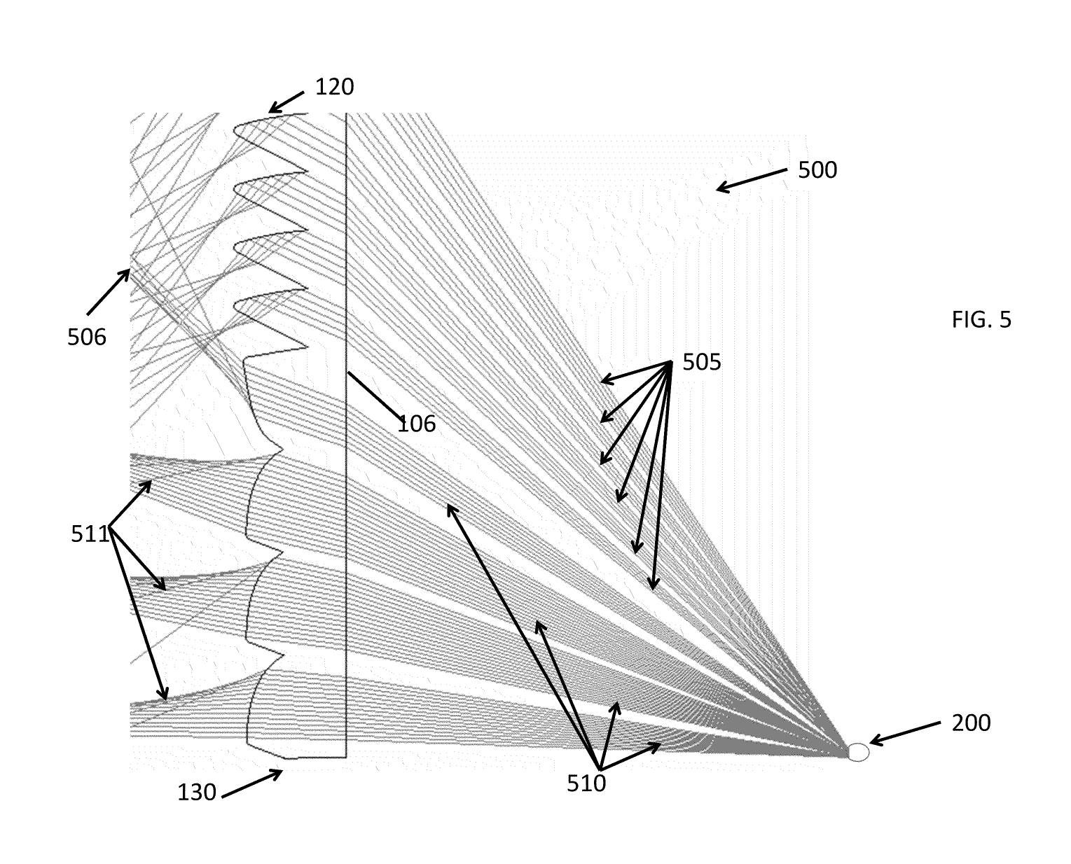

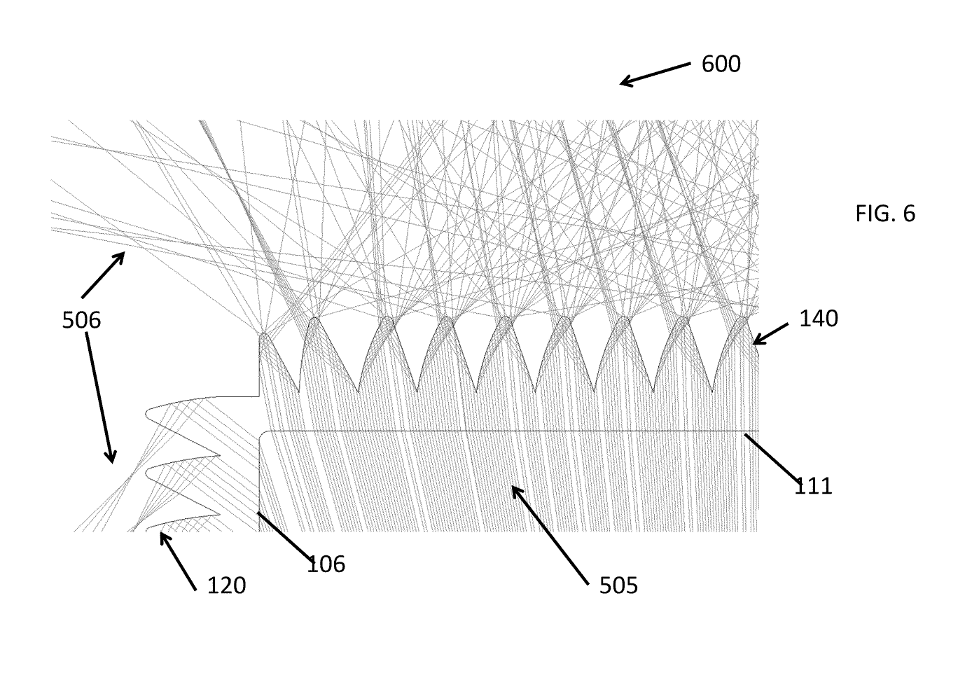

FIG. 5 illustrates a ray trace diagram 500 illustrating light rays from an idealized point source 200 passing through the first series of circumferentially arranged facets 120 and the second series of circumferentially arranged facets 130. FIG. 6 illustrates a ray trace diagram 600 illustrating light rays from the same idealized point source 200 passing through the series of concentrically arranged facets 140.

In one embodiment, the first series of circumferentially arranged facets 120 and the series of concentrically arranged facets 140 are TIR facets designed to totally internally reflect light rays 505 from the idealized point light source 200. As described further herein, light rays 505 from the point light source 200 incident on the smooth inner surfaces 106, 111, adjacent the first series of circumferentially arranged facets 120 and the series of concentrically arranged facets 140, are refracted slightly before being totally internally reflected respectively in the first series of circumferentially arranged facets 120 and the series of concentrically arranged facets 140, and reflected externally and omnidirectionally from the omnidirectional lens 100, as external rays 506. Though all the rays from idealized point source will be reflected downward by the circumferentially arranged facets 120, some uncontrolled light rays will escape from the facet in other directions when a real light source is employed with the omnidirectional lens 100.

In one embodiment, the second series of circumferentially arranged facets 130 are refractive facets designed to refract light rays 510 from the idealized point light source 200. As described further herein, light rays 510 from the point light source 200 incident on the smooth inner surface 106, adjacent the second series of circumferentially arranged facets 120, are refracted through the second series of circumferentially arranged facets 130 and pass externally and omnidirectionally from the omnidirectional lens 100, as external rays 511.

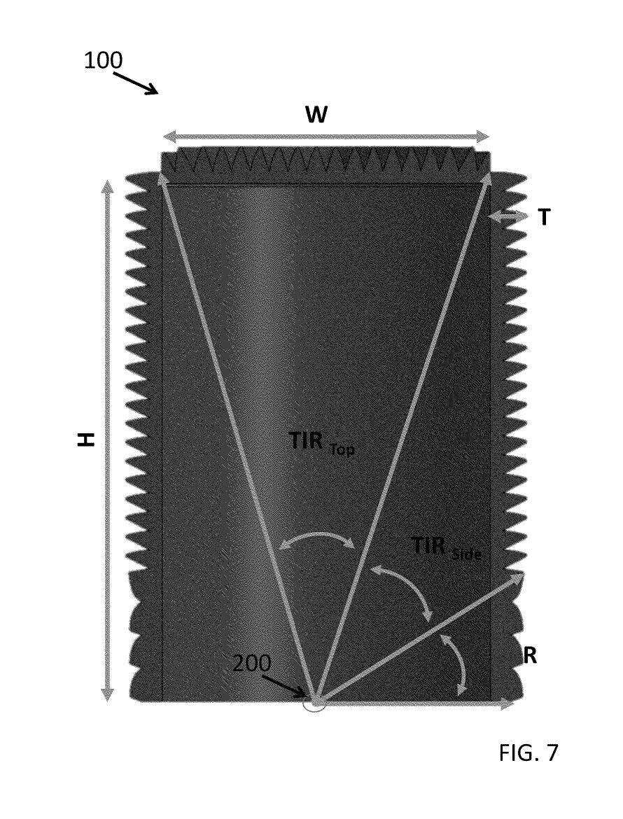

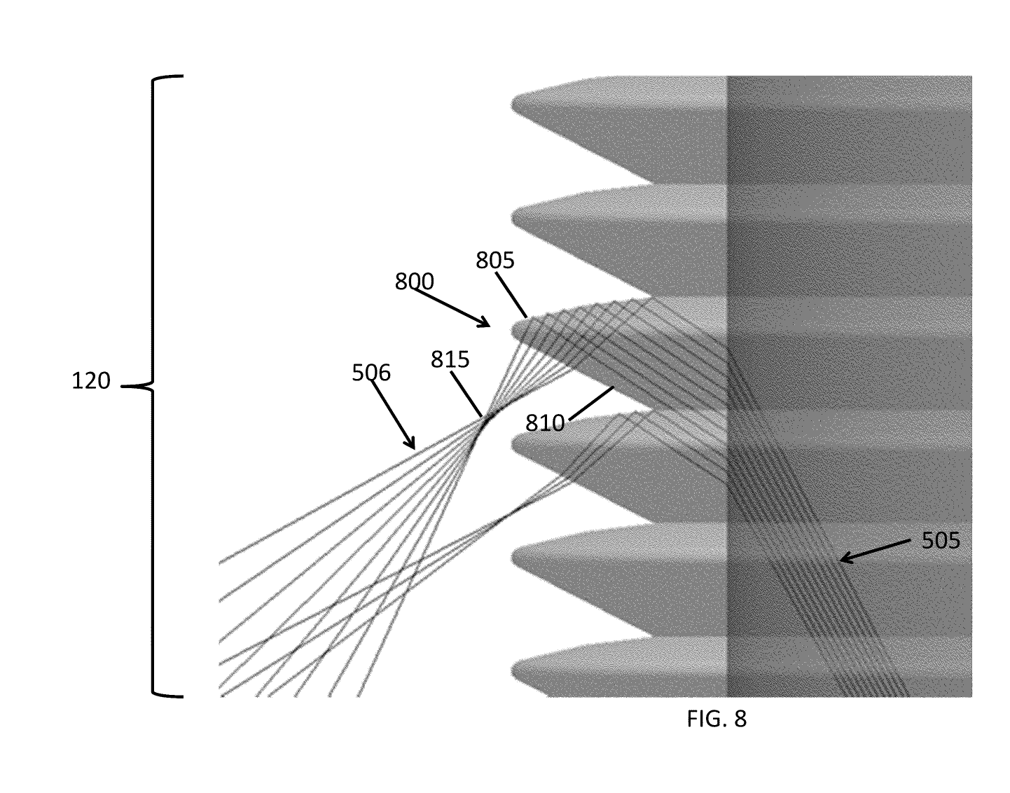

FIG. 7 illustrates a side view of the omnidirectional lens 100 of FIGS. 1-4, showing lens details and angles. As illustrated, the omnidirectional lens 100 can be broken into several zones. In one embodiment, the zones are angles through which the rays 505, 510 travel. The zones include a refractive zone, R, a total internal reflection side zone TIR_{Side}, and a total internal reflection top zone TIR_{Top}. For example, in the R zone, the light rays 510 from the point light source 200 travel within the angle defined within the R zone. For example, the angle of the R zone can be about 33.1°. In addition, in the TIR_{Side} zone, the light rays 505 from the point light source 200 travel within the angle defined within the TIR_{Side} zone. For example, the angle of the TIR_{Side} zone can be about 39.8°. In addition, in the TIR_{Top} zone, the light rays 505 from the point light source 200 travel within the angle defined within the TIR_{Top} zone. For example, the angle of the TIR_{Top} zone can be about 34.2°. It is appreciated that the angles defined herein are examples only, illustrating the behavior of the various light rays from the idealized point light source 200.

The exemplary angles are dependent on the dimensions of the omnidirectional lens 100. The size of the angular zones relative to each other control the ratio of light passing through each type of facet and thus the amount of light directed upwards, downwards, and sideways with respect to the lens. If the overall intensity distribution has too much uplight relative to downlight, the size of the TIR_{Side} zone can be increased and the size of the TIR_{Top} zone decreased in order to correct this. In general, however, the relative intensities in each direction and thus the sizes of the three zones must be substantially similar in order to provide an overall intensity distribution that is omnidirectional.

Illustrative examples of dimensions of the omnidirectional lens 100 are now described. It is further understood that the following description is an example only and not limiting of various other dimensions possible in other embodiments. For example, the omnidirectional lens 100 can include a non-idealized source with a diameter D_{Source}, which can be about 15 mm. In addition, the thickness, T, of each of the facets in the first series of circumferentially arranged facets 120 and the series of concentrically arranged facets 140 can be about 2.2 mm. Furthermore, the width, W, of the omnidirectional lens 100 can be about 1.333*D_{Source}, and the height, H, can be about 2.107*D_{Source}. The source diameter, D_{Source}, is arbitrary and is determined by how many or how large of LEDs are needed to provide the required amount of light. In an exemplary embodiment a 15 mm LED source was needed to provide the required amount of light. D_{Source} is not currently shown visually in any of the figures. The overall size of the lens is determined by several factors. The bigger the lens in comparison to the source, the closer the real source will behave like a point source. Alternatively, it is generally preferred to have the lens be smaller so that there is room for the diffuser and other lamp components.

FIG. 8 illustrates a close up detailed view of the first series of circumferentially arranged facets 120. The following description applies to design considerations for both the first series of circumferentially arranged facets 120, and the series of concentrically arranged facets 140, both of which totally internally reflect the light rays 505 as described herein.

For illustrative purposes, reference is made to one facet 800 of the first series of circumferentially arranged facets 120. It is appreciated that the description applies to all of the facets of the first series of circumferentially arranged facets 120, and the series of concentrically arranged facets 140. In one embodiment, each facet of the first series of circumferentially arranged facets 120, and the series of concentrically arranged facets 140 is designed to reflect incoming light rays 505 from a point light source 200, off a top surface 805 of the facet 800 and through an outward exit face 810 of the facet 800. It will be appreciated from FIG. 6 that each opposing face in the concentrically arranged facets 140 serves to reflect incoming light rays 505 that are incident on it while also serving as the exit face for light rays 505 that were incident on and then totally internally reflected by the opposing face.

The facet 800 converges the light rays 505 through an approximate focal point 815 near the exit face 810 so that the light rays 506 spread out as the move away from the omnidirectional lens 100. In one embodiment, a curvature of the top surface 805 and an angle of the exit face 810 define the location of approximate focal point 815, the angle of the light rays 506 with respect to the exit face 810, and a degree of spread of the light rays 506. For example the location of the approximate focal point can be moved away from the tip of the adjacent facet by increasing the angle between the top surface 805 and the exit face 810. Similarly, the degree of spread of the light rays 506 can be increased by increasing the curvature of the top surface 805 or decreased by flattening the top surface 805. As described herein, the top surface uses TIR to reflect the light rays 505. An acceptance angle of each facet 800 (which is defined by facet height) is set so that all the light rays 505 from the idealized point source that hit the top surface 805 will exceed the critical angle of material used in the omnidirectional lens 100. For example, the critical angle is 42.2° for poly(methyl methacrylate) (PMMA), and the critical angle is 39.1° for polycarbonate. As such, the acceptance angle can be selected based on the critical angle of the material used. In addition, the top surface 805 is designed so that the light rays 506 leaving the exit face 810 miss adjacent facets.

In an exemplary embodiment, each refractive facet of a second series of circumferentially arranged facets 130 is designed so that light rays from the point source 200 are converged to an approximate focal point that is father away from the lens than that of the TIR facet 800. The backside of each facet (sometimes called the draft side) is angled so that it is easier to pull the lens out of the mold. The uppermost refractive facet is reversed with respect to the other refractive facets so that draft surface of that facet can be used to TIR light that is incident on it and prevent this light from reaching TIR facet above.

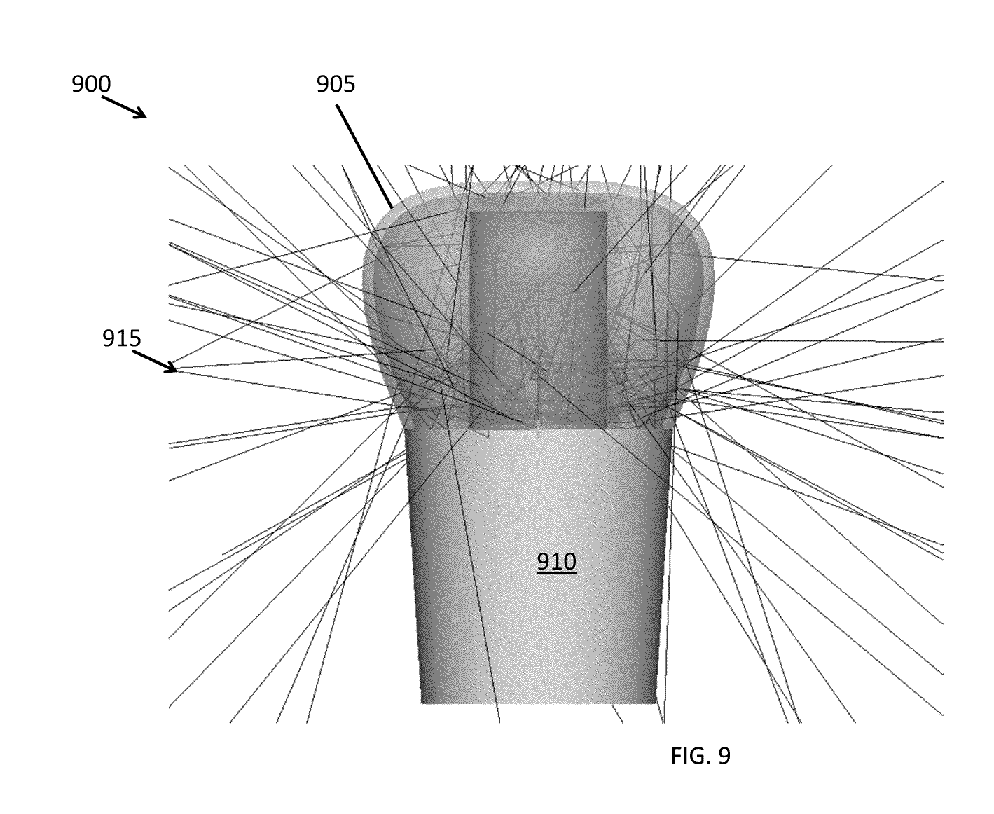

FIG. 9 illustrates an embodiment of a diffuser 905 that can be implemented with the omnidirectional lens of FIGS. 1-4 in a lamp system 900. In one embodiment, the omnidirectional lens 100 can be implemented with a non-point source, which can be an array of LEDs. When the omnidirectional lens 100 lens is used with a non-point source, a portion of the light can exit the omnidirectional lens 100 in an uncontrolled manner (i.e., often referred to as leaking) because the actual ray trajectories differ significantly from those of the point source to which the optical surfaces were designed.

This effect must be taken into account during the omnidirectional lens 100 design, but can help to reduce glare from the optic by starting to smooth out any sharp peaks in the intensity distribution caused by the individual facets 800. In some cases the leaked light is not sufficient to adequately smooth the distribution. As such, in one embodiment, a diffuser element, such as a diffuser 905 is implemented to surround the omnidirectional lens. FIG. 9 illustrates a lamp system 900, which includes the omnidirectional lens 100 surrounded by the weak diffuser 905.

For illustrative purposes, a heat sink 910 is shown to complete the lamp system 900 as illustrated. In one embodiment, the strength of the diffuser is often fairly weak (i.e. the spread from the material has a full width at half maximum (FWHM) less than 60°) though heavier diffusers can be used as well in other embodiments. The diffuser 905 may be shaped such that the sides are angled down towards the base of the lamp system 900 so that the smoothing effect of the diffuser does not prevent the light from being directed towards the base of the lamp, as shown by exit rays 915. In one embodiment, the shape of the diffuser and heat sink may be varied for different applications or for aesthetics.

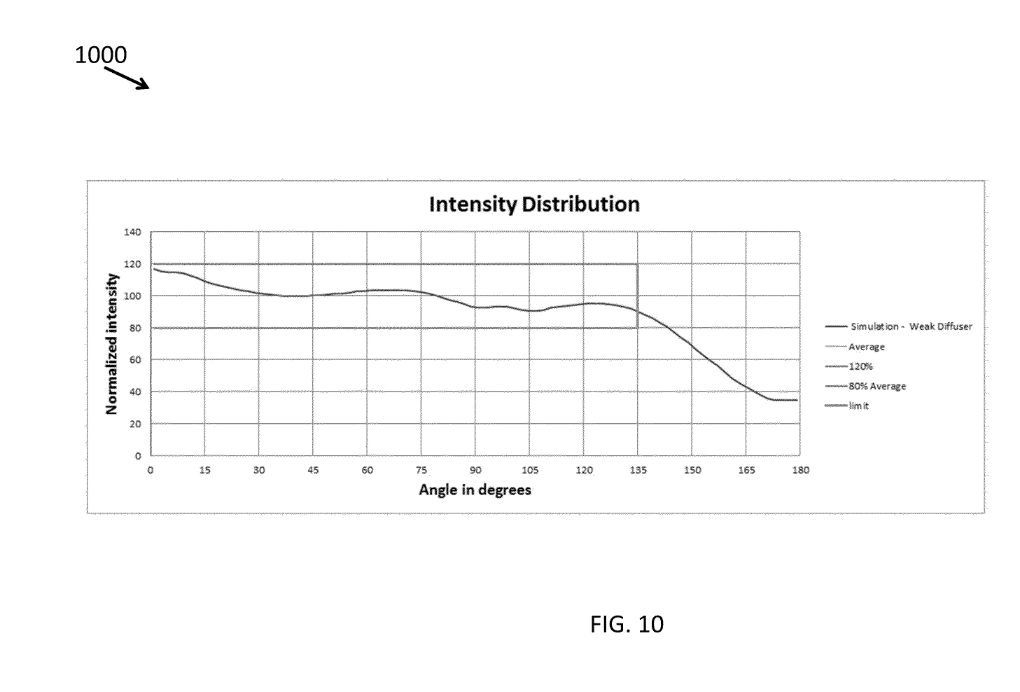

FIG. 10 illustrates a plot 1000 showing a normalized intensity distribution for the exemplary lens 100 of FIG. 1 and the lamp 900 of FIG. 9. This plot shows that the intensity distribution between 0 and 135 degrees around the lamp varies from the average by less than 20% and thus exceeds the Energy Star requirements for an omnidirectional distribution. By meeting these requirements the solid state lamp 900 demonstrates that it will produce a luminous intensity distribution that meets or exceeds the omnidirectional standard of the incandescent lamp it is intended to replace.

### CONCLUSION

A combination of a thin TIR ring lens similar to a Fresnel lens and a diffuser is implemented for omnidirectional LED lamps meeting the Energy Star omnidirectionality requirements established by the EPA. Specifically, the lamp exhibits a uniform intensity distribution, within a 25% tolerance, over the range from 0 to 135 degrees around the lamp. The omnidirectional lens and diffuser system also work well for A19, A21 or similar type of lamp configurations, such as but not limited to candelabra lamps. Finally, lens and diffuser system have low optical losses with an optical efficiency above 85%.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

What is claimed is:

1. An omnidirectional lens, comprising:
a housing having a closed end and an open end;
a plurality of facets circumferentially arranged on the housing; and
a plurality of concentric facets disposed on the closed end.

2. The omnidirectional lens as claimed in claim 1 wherein the plurality of facets circumferentially arranged on the housing includes a first plurality of facets circumferentially arranged on the housing, and a second plurality of facets circumferentially arranged on the housing.

3. The omnidirectional lens as claimed in claim 2 wherein the first plurality of facets circumferentially arranged on the housing are total internal reflection facets.

4. The omnidirectional lens as claimed in claim 3 wherein each facet of the first plurality of facets circumferentially arranged on the housing include a top surface and an outward exit face disposed at an angle with respect to the top surface.

5. The omnidirectional lens as claimed in claim 2 wherein the second plurality of facets circumferentially arranged on the housing are refraction facets.

6. The omnidirectional lens as claimed in claim 2 wherein the plurality of concentric facets are total internal reflection facets.

7. The omnidirectional lens as claimed in claim 6 wherein each facet of the plurality of concentric facets includes a top surface and an outward exit face disposed at an angle with respect to the top surface.

8. A lighting device comprising:
an omnidirectional lens having a housing with a closed end and an open end, the housing having a refraction zone, a total internal reflection side zone and a total internal reflection top zone;
a light source disposed within the housing;
a first plurality of facets circumferentially arranged on the housing;
a second plurality of facets circumferentially arranged on the housing; and
a plurality of concentric facets disposed on the closed end.

9. The omnidirectional lens as claimed in claim 8 wherein the first plurality of facets circumferentially arranged on the housing are total internal reflection facets.

10. The omnidirectional lens as claimed in claim 9 wherein each facet of the first plurality of facets circumferentially arranged on the housing include a top surface and an outward exit face disposed at an angle with respect to the top surface.

11. The omnidirectional lens as claimed in claim 9 wherein the total internal reflection side zone defines angles through which light rays from the light source enter the first plurality of facets circumferentially arranged on the housing.

12. The omnidirectional lens as claimed in claim 8 wherein the second plurality of facets circumferentially arranged on the housing are refraction facets.

13. The omnidirectional lens as claimed in claim 10 wherein the refraction zone defines angles through which light rays from the light source enter the second plurality of facets circumferentially arranged on the housing.

14. The omnidirectional lens as claimed in claim 8 wherein the plurality of concentric facets are total internal reflection facets.

15. The omnidirectional lens as claimed in claim 14 wherein each facet of the plurality of concentric facets includes a top surface and an outward exit face disposed at an angle with respect to the top surface.

16. The omnidirectional lens as claimed in claim 14 wherein the total internal reflection top zone defines angles through which light rays from the light source enter the plurality of concentric facets.

17. A lamp system, comprising:
a light source;
an omnidirectional lens disposed around the light source, the omnidirectional lens having a housing with a closed end and an open end, a plurality of facets circumferentially arranged on the housing, and a plurality of concentric facets disposed on the closed end;
a diffuser disposed around said omnidirectional lens; and
a heat dissipating assembly coupled to the light source.

18. The lamp system as claimed in claim 17 wherein the omnidirectional lens, comprises
a housing having a closed end and an open end;
a first plurality of facets circumferentially arranged on the housing;
a second plurality of facets circumferentially arranged on the housing; and
a plurality of concentric facets disposed on the closed end.

19. The lamp system as claimed in claim 18 wherein the first plurality of facets circumferentially arranged on the housing, and the plurality of concentric facets are total internal reflection facets.

20. The lamp system as claimed in claim 18 wherein the second plurality of facets circumferentially arranged on the housing are refraction facets.
